(19) United States
(12) Patent Application Publication
(10) Pub. No.: US 2012/0310518 A1
(43) Pub. Date: Dec. 6, 2012

(54) VEHICLE COLLISION AVOIDANCE APPARATUS, VEHICLE COLLISION AVOIDANCE METHOD AND COMPUTER PROGRAM PRODUCT THEREOF

(75) Inventors: Lien-Wu Chen, Zhongli City (TW); Yu-Chee Tseng, Hsinchu City (TW); Yu-Hao Peng, Taipei City (TW)

(73) Assignee: INSTITUTE FOR INFORMATION INDUSTRY, Taipei (TW)

(21) Appl. No.: 13/196,581

(22) Filed: Aug. 2, 2011

(30) Foreign Application Priority Data
May 30, 2011 (TW) 100118772

(51) Int. Cl. G08G 1/16

(52) U.S. Cl. 701/301

(57) ABSTRACT

A vehicle collision avoidance apparatus, a vehicle collision avoidance method, and a computer program product thereof are provided. The vehicle collision avoidance apparatus is disposed on a vehicle and is used to prevent the vehicle from crashing into a front vehicle. There is further a back vehicle behind the vehicle. The front vehicle will transmit a warning message to the vehicle collision avoidance apparatus disposed on the vehicle when the front vehicle brakes. The vehicle collision avoidance apparatus disposed on the vehicle will send out a warning notification in response to the warning message, and transmit the warning message to the back vehicle. Similarly, the vehicle collision avoidance apparatus can also be disposed on the front vehicle and the back vehicle to execute the same operations.

This application claims priority to Taiwan Patent Application No. 100118772 filed on May 30, 2011, which is hereby incorporated by reference in its entirety.

### FIELD

The present invention relates to a vehicle collision avoidance apparatus, a vehicle collision avoidance method and a computer program product thereof. More particularly, the present invention relates to a vehicle collision avoidance apparatus, a vehicle collision avoidance method and a computer program product thereof for avoiding collision with a front vehicle.

### BACKGROUND

Owing to development of the automobile industry, the amount of vehicles in almost every country is increasing rapidly. Consequently, traffic management has become a big problem in areas having a high density of vehicles. On the other hand, as the consumers become more and more concerned about the safety of driving, the vehicle manufacturers have put great efforts in research and development of on-board computing apparatuses so that various driving assistance systems can be equipped on commercial vehicles to improve the added value of the vehicles. Among such on-board computing apparatuses, the vehicle collision avoidance systems are the most important.

Generally speaking, conventional vehicle collision avoidance technologies all have the following limitations: (1) they must rely on the Global Positioning System (GPS) in order to provide vehicles with position information; (2) information about positions and speeds of nearby vehicles can only be obtained through periodical beacon advertisement; and (3) a roadside infrastructure must be deployed to provide vehicles with information and to transmit related messages. Correspondingly, the conventional vehicle collision avoidance systems have the following shortcomings: (1) an error ranging from ten meters to several tens of meters may exist in the geological position information provided by the GPS due to the atmospheric effect and the multi-path effect; (2) the periodical beacon advertisement consumes the limited wireless bandwidth resources; (3) deployment of the roadside infrastructure consumes massive manpower, materials and financial resources; and (4) a warning message indicating an emergency brake event is often broadcast to a lot of unrelated vehicles that have already kept a safe distance or that are driving in other lanes, and this unnecessarily wastes a lot of valuable wireless bandwidth resources and increases the packet collision probability in transmission of the warning message.

Accordingly, an urgent need exists in the art to provide a vehicle collision avoidance apparatus and a vehicle collision avoidance method that eliminate the need of using the GPS, the need of periodical beacon advertisement and the need of deploying a roadside infrastructure.

### SUMMARY

An objective of the present invention is to provide a vehicle collision avoidance apparatus for avoiding collision with a first vehicle. The first vehicle has a first warning list, the vehicle collision avoidance apparatus is disposed on a second vehicle, and the second vehicle is able to calculate a safe distance and is apart from the first vehicle by a distance. The vehicle collision avoidance apparatus comprises an identification (ID) identifying unit, a distance detecting unit, and a message transmission and warning unit. The ID identifying unit is configured to identify an ID of the first vehicle so that the message transmission and warning unit can transmit a message according to the ID of the first vehicle. The distance detecting unit is configured to generate a first detection result when the distance is less than the safe distance. The message transmission and warning unit, which is electrically connected to the distance detecting unit, is configured to transmit a first join-in message to the first vehicle in response to the first detection result. The first vehicle adds the second vehicle into the first warning list in response to the first join-in message so that the first vehicle transmits a first warning message to the message transmission and warning unit according to the first warning list when the first vehicle brakes. The message transmission and warning unit is further configured to send out a warning notification in response to the first warning message.

The message transmission and warning unit further comprises a second warning list, and there is further a third vehicle behind the second vehicle. The third vehicle transmits a second join-in message to the message transmission and warning unit, and the message transmission and warning unit is further configured to add the third vehicle into the second warning list in response to the second join-in message and to transmit the first warning message to the third vehicle. Likewise, the vehicle collision avoidance apparatus may also be disposed on the first vehicle and the third vehicle to execute the same operations.

Another objective of the present invention is to provide a vehicle collision avoidance method for the vehicle collision avoidance apparatus described above. The vehicle collision avoidance apparatus is configured to avoid collision with a first vehicle and is disposed on a second vehicle. The vehicle collision avoidance apparatus comprises an ID identifying unit, a distance detecting unit and a message transmission and warning unit. The ID identifying unit is configured to identify an ID of the first vehicle so that the message transmission and warning unit can transmit a message according to the ID of the first vehicle. The message transmission and warning unit is electrically connected to the distance detecting unit. The first vehicle has a first warning list, and the second vehicle is able to calculate a safe distance and is apart from the first vehicle by a distance. The vehicle collision avoidance method comprises the following steps of: (a) enabling the distance detecting unit to generate a first detection result when the distance is less than the safe distance; (b) enabling the message transmission and warning unit to transmit a first join-in message to the first vehicle in response to the first detection result; and (c) enabling the message transmission and warning unit to send out a warning notification. The first vehicle adds the second vehicle into the first warning list in response to the first join-in message so that the first vehicle transmits a first warning message to the message transmission and warning unit according to the first warning list when the first vehicle brakes. The message transmission and warning unit is further configured to send out the warning notification in response to the first warning message.

The message transmission and warning unit further comprises a second warning list, and there is further a third vehicle behind the second vehicle. The third vehicle transmits a second join-in message to the message transmission and warning unit. The vehicle collision avoidance method further comprises the following steps of: (d) enabling the message transmission and warning unit to add the third vehicle into the second warning list in response to the second join-in message; and (e) enabling the message transmission and warning unit to transmit the first warning message to the third vehicle. Likewise, the vehicle collision avoidance apparatus may also be disposed on the first vehicle and the third vehicle to execute the same operations.

A further objective of the present invention is to provide a computer program product, which stores a program of a vehicle collision avoidance method for a vehicle collision avoidance apparatus. The vehicle collision avoidance apparatus is configured to avoid collision with a first vehicle and is disposed on a second vehicle. The vehicle collision avoidance apparatus comprises an ID identifying unit, a distance detecting unit and a message transmission and warning unit. The ID identifying unit is configured to identify an ID of the first vehicle so that the message transmission and warning unit can transmit a message according to the ID of the first vehicle. The message transmission and warning unit is electrically connected to the distance detecting unit. The first vehicle has a first warning list, and the second vehicle is able to calculate a safe distance and is apart from the first vehicle by a distance. The program comprises: a code A for enabling the distance detecting unit to generate a first detection result when the distance is less than the safe distance; a code B for enabling the message transmission and warning unit to transmit a first join-in message to the first vehicle in response to the first detection result; and a code C for enabling the message transmission and warning unit to send out a warning notification. The first vehicle adds the second vehicle into the first warning list in response to the first join-in message so that the first vehicle transmits a first warning message to the message transmission and warning unit according to the first warning list when the first vehicle brakes. The message transmission and warning unit is further configured to send out the warning notification.

The message transmission and warning unit further comprises a second warning list, and there is further a third vehicle behind the second vehicle. The third vehicle transmits a second join-in message to the message transmission and warning unit. Correspondingly, the program further comprises: a code D for enabling the message transmission and warning unit to add the third vehicle into the second warning list in response to the second join-in message; and a code E for enabling the message transmission and warning unit to transmit the first warning message to the third vehicle. Likewise, the vehicle collision avoidance apparatus may also be disposed on the first vehicle and the third vehicle to execute the same operations.

According to the vehicle collision avoidance apparatus of the present invention, a distance detecting unit is used to detect that the second vehicle does not keep a safe distance from the first vehicle and to generate a detection result. Then, the message transmission and warning unit transmits a first join-in message to the first vehicle in response to the detection result so that the first vehicle can add the second vehicle into a first warning list in response to the first join-in message. Thus, the first vehicle can transmit a first warning message to the message transmission and warning unit according to the first warning list when the first vehicle brakes so that the message transmission and warning unit sends out a warning notification in response to the first warning message.

The message transmission and warning unit further has a second warning list, and there is further a third vehicle behind the second vehicle. The third vehicle transmits a second join-in message to the message transmission and warning unit, and the message transmission and warning unit is further configured to add the third vehicle into the second warning list in response to the second join-in message and to transmit the first warning message to the third vehicle so that the third vehicle can decelerate correspondingly. Furthermore, the vehicle collision avoidance apparatus may also be disposed on the first vehicle and the third vehicle to execute the same operations. Thereby, the present invention can overcome the shortcomings of the conventional vehicle collision avoidance technologies that they must rely on the GPS, the periodical beacon advertisement and massive roadside infrastructure, and also has an advantage of saving the wireless bandwidth resources.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a first embodiment of the present invention;

FIG. 1B is a schematic view of a vehicle collision avoidance apparatus disposed on a first vehicle;

FIG. 1C is a schematic view of a vehicle collision avoidance apparatus disposed on a second vehicle;

FIG. 1D is a schematic view of a vehicle collision avoidance apparatus disposed on a third vehicle;

FIG. 2 is a state transition diagram of grouped vehicles according to the present invention;

FIG. 3 is a schematic view depicting driving conditions; and

FIGS. 4A-4B depict a flowchart of a second embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

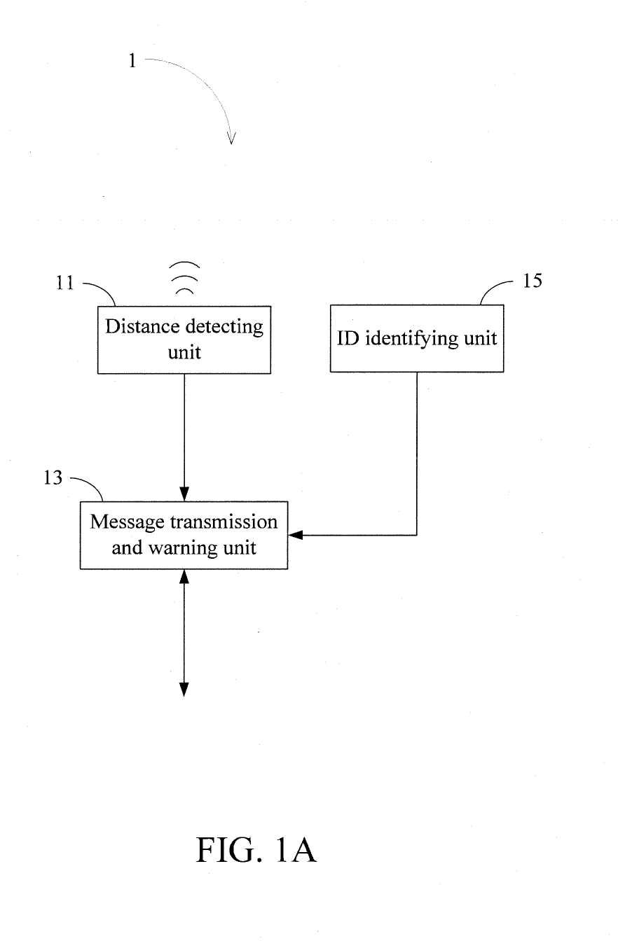

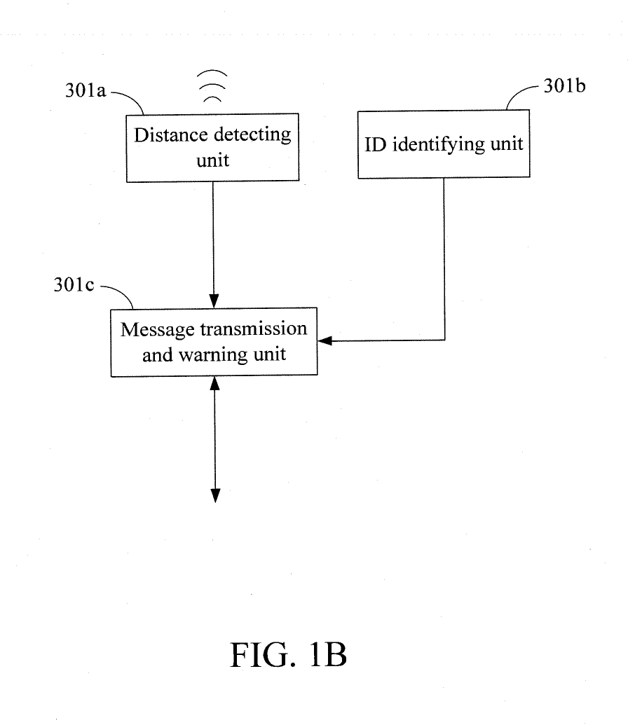

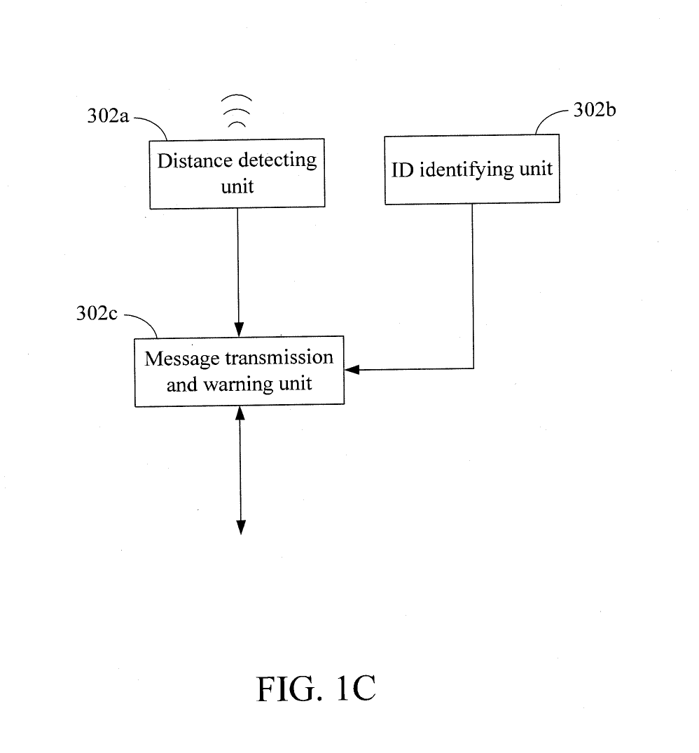

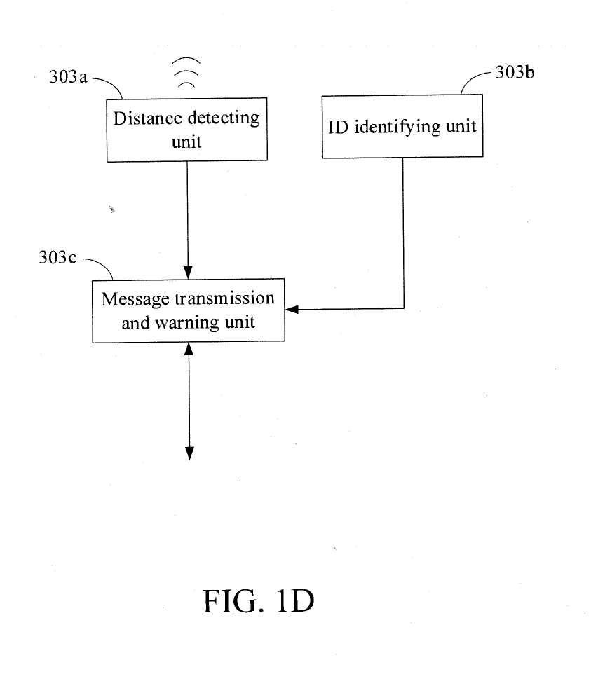

A first embodiment of the present invention is a vehicle collision avoidance apparatus 1, a schematic view of which is depicted in FIG. 1A. The vehicle collision avoidance apparatus 1 comprises a distance detecting unit 11, an identification (ID) identifying unit 13 and a message transmission and warning unit 15. The distance detecting unit 11 and the ID identifying unit 13 are electrically connected to the message transmission and warning unit 15 respectively. The distance detecting unit 11 is configured to measure a distance from a front vehicle, and may be a magnetic sensor, an ultrasonic sensor, a laser rangefinder or some other device used to measure a distance between vehicles. The ID identifying unit 13 is configured to identify an ID of a vehicle, and may be a video camera or a still camera capable of identifying a vehicle license plate, a radio frequency ID reader (RFID reader) or some other device used to identify a vehicle ID. The message transmission and warning unit 15 is configured to execute a grouped warning algorithm and send out a warning notification, and may be an on board unit (OBU), an electronic control unit (ECU), a communication device or some other device capable of executing the grouped warning algorithm. Details of the grouped warning algorithm will be described later.

Further speaking, the message transmission and warning unit 15 may comprise a processing unit, a storage unit, an audio unit or a display unit (not shown in FIG. 1A), or some other device with the same functionality and well known to those of ordinary skill in the art. The processing unit may be any of various processors, central processing units (CPUs), microprocessors, calculators or devices with a computing capability and well known to those of ordinary skill in the art, either currently available or to be developed in the future. The storage unit may be a memory, a floppy disk, a hard disk, a compact disk (CD), a mobile disk, a magnetic tape, a database accessible to networks, or any other storage media with the same functionality and well known to those skilled in the art. The audio unit may be a loud speaker, a buzzer or some other device with a sound warning functionality and well known to those of ordinary skill in the art. The display unit may be a head-up display (HUD), a light emitting diode (LED) warning light or some other device with a visual warning functionality and well known to those of ordinary skill in the art.

The vehicle collision avoidance apparatus 1 may be disposed on a vehicle. Specifically, the distance detecting unit 11, the ID identifying unit 13 and the message transmission and warning unit 15 may be integrated into a single apparatus and disposed at any feasible position in a driving cab or on a vehicle body. Alternatively, the distance detecting unit 11, the ID identifying unit 13 and the message transmission and warning unit 15 may also be provided as three separate devices disposed at three feasible positions in a driving cab or on a vehicle body; in this case, the distance detecting unit 11 and the ID identifying unit 13 are electrically connected to the message transmission and warning unit 15 wirelessly or through a wired connection. How the vehicle collision avoidance apparatus 1 is disposed is not intended to limit the scope of the present invention.

It shall be appreciated that, the aforesaid examples of the distance detecting unit 11, the ID identifying unit 13, the message transmission and warning unit 15 and the components thereof are only intended to illustrate the principles, technical means and effects of the present invention, but not to limit the scope of the present invention. Implementations of the vehicle collision avoidance apparatus 1 is not limited to what described above.

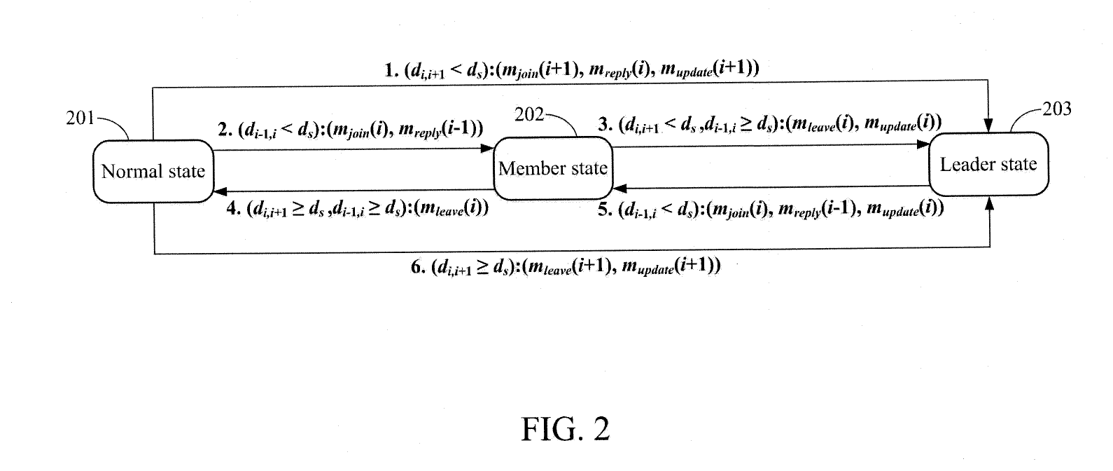

Hereinafter, how the vehicle collision avoidance apparatus of the present invention groups vehicles will be described. Referring to FIG. 2, there is shown a state transition diagram of grouped vehicles. As shown, the state transition diagram comprises three states, namely, a normal state 201, a member state 202 and a leader state 203. In this state transition diagram, a vehicle i−1, a vehicle i and a vehicle i+1 will be taken as an example to describe state transitions of the vehicles. The vehicle i−1 is in front of the vehicle i, and the vehicle i+1 is at the back of the vehicle i. All the vehicle i−1, the vehicle i and the vehicle i+1 are equipped with a vehicle collision avoidance apparatus 1.

Hereinbelow, the vehicle i will be taken as an example to describe the normal state 201, the member state 202 and the leader state 203. The normal state 201 represents that the vehicle i keeps a safe distance from both the vehicle i−1 and the vehicle i+1; i.e., a distance d_{i-1,i} between the vehicle i and the vehicle i−1 is greater than a safe distance dₛ, and a distance d_{i+1,i} between the vehicle i and the vehicle i+1 is also greater than the safe distance dₛ. The member state 202 represents that the vehicle i fails to keep a safe distance from the vehicle i−1; i.e., the distance between the vehicle i and the vehicle i−1 is smaller than the safe distance dₛ. The leader state 203 represents that the vehicle i keeps a safe distance from the vehicle i−1 but does not have a safe distance from the vehicle i+1; i.e., the distance d_{i-1,i} between the vehicle i and the vehicle i−1 is greater than a safe distance dₛ, but the distance d_{i,i+1} between the vehicle i and the vehicle i+1 is smaller than the safe distance dₛ.

It shall be additionally noted that, the safe distance dₛ is calculated by the distance detecting unit disposed in the vehicle i according to a driving speed of the vehicle i. For example, the safe distance for a small vehicle is generally (the driving speed/2) meters, wherein the driving speed is in a unit of kilometers/hour, and the value of (the driving speed/2) meters is considered as the safe distance that a small vehicle shall keep from a front vehicle. Because the safe distance dₛ is related to the type of the vehicle and the actual driving conditions, it may also be calculated in other ways in other embodiments, and the way in which the safe distance dₛ is calculated is not intended to limit the scope of the present invention.

Now, how the vehicle collision avoidance apparatus 1 determines state transitions during a vehicle grouping process and operations to be performed during the state transitions will be described. The state transition diagram of FIG. 2 is represented in a format of (event):(action), which will be detailed as follows.

State transition 1 (from the normal state 201 to the leader state 203): here, it is assumed that the vehicle i is initially in the normal state 201. When the vehicle i+1 detects that the distance d_{i,i+1} between the vehicle i+1 and the vehicle i is smaller than a safe distance dₛ₍ᵢ₊₁₎ of the vehicle i+1, the vehicle i+1 transmits a join-in message mⱼₒᵢₙ(i+1) to the vehicle i. Then, the vehicle i transmits a reply message m_{reply}(i) to the vehicle i+1 in response to the join-in message mⱼₒᵢₙ(i+1). The vehicle i+1 transmits an update message m_{update}(i+1) after receiving the reply message m_{reply}(i), and then the vehicle i turns from the normal state 201 into the leader state 203.

State transition 2 (from the normal state 201 to the member state 202): here, it is assumed that the vehicle i is initially in the normal state 201. When the vehicle i detects that the distance d_{i-1,i} between the vehicle i and the vehicle i−1 is smaller than a safe distance dₛ₍ᵢ₎ of the vehicle i, the vehicle i transmits a join-in message mⱼₒᵢₙ(i) to the vehicle i−1. Next, the vehicle i−1 transmits a reply message m_{reply}(i−1) to the vehicle i in response to the join-in message mⱼₒᵢₙ(i). Then, the vehicle i turns from the normal state 201 into the member state 202.

State transition 3 (from the member state 202 to the leader state 203): here, it is assumed that the vehicle i is initially in the member state 202. When the vehicle i detects that the distance d_{i-1,i} between the vehicle i and the vehicle i−1 is greater than a safe distance dₛ₍ᵢ₎ of the vehicle i and the distance d_{1,i+1} between the vehicle i+1 and the vehicle i is smaller than a safe distance dₛ₍ᵢ₊₁₎ of the vehicle i+1, the vehicle i transmits a leaving message mₗₑₐᵥₑ(i) to the vehicle i−1 and transmits an update message m_{update}(i). Then, the vehicle i turns from the member state 202 into the leader state 203.

State transition 4 (from the member state 202 to the normal state 201): here, it is assumed that the vehicle i is initially in the member state 202. When the vehicle i detects that the distance d_{i-1,i} between the vehicle i and the vehicle i−1 is greater than a safe distance dₛ₍ᵢ₎ of the vehicle i and the distance d_{i,i+1} between the vehicle i+1 and the vehicle i is greater than a safe distance dₛ₍ᵢ₊₁₎ of the vehicle i+1, the vehicle i transmits a leaving message mₗₑₐᵥₑ(i) to the vehicle i−1. Then, the vehicle i turns from the member state 202 into the normal state 201.

State transition 5 (from the leader state 203 to the member state 202): here, it is assumed that the vehicle i is initially in the leader state 203. When the vehicle i detects that the distance d_{i-1,i} between the vehicle i and the vehicle i−1 is smaller than a safe distance dₛ₍ᵢ₎ of the vehicle i, the vehicle i transmits a join-in message mⱼₒᵢₙ(i) to the vehicle i−1, and the vehicle i−1 transmits a reply message m_{reply}(i−1) to the vehicle i in response to the join-in message mⱼₒᵢₙ(i). The vehicle i transmits an update message m_{update}(i) after receiving the reply message m_{reply}(i−1), and then the vehicle i turns from the leader state 203 into the member state 202.

State transition 6 (from the leader state 203 to the normal state 201): here, it is assumed that the vehicle i is initially in the leader state 203. When the vehicle i+1 detects that the distance d_{i,i+1} between the vehicle i+1 and the vehicle i is greater than a safe distance dₛ₍ᵢ₊₁₎ of the vehicle i+1, the vehicle i+1 transmits a leaving message mₗₑₐᵥₑ(i+1) to the vehicle i and transmits an update message m_{update}(i+1). Then, the vehicle i turns from the leader state 203 into the normal state 201.

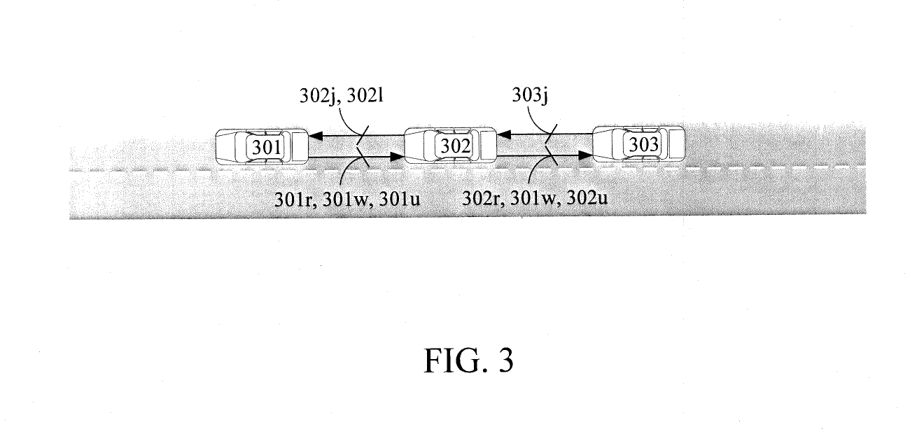

For example, referring to FIG. 3, there is shown a schematic view depicting driving conditions. As shown, a first vehicle 301, a second vehicle 302 and a third vehicle 303 are driving on a same lane, and are each equipped with a vehicle collision avoidance apparatus 1. Referring to FIG. 1B to FIG. 1D together, for purpose of convenience, the distance detecting unit, the ID identifying unit and the message transmission and warning unit disposed on the first vehicle 301 will be denoted by 301a, 301b, 301c respectively, the distance detecting unit, the ID identifying unit and the message transmission and warning unit disposed on the second vehicle 302 will be denoted by 302a, 302b, 302c respectively, and the distance detecting unit, the ID identifying unit and the message transmission and warning unit disposed on the third vehicle 303 will be denoted by 303a, 303b, 303c respectively hereinbelow. The message transmission and warning unit 301c has a first warning list stored therein, the message transmission and warning unit 302c has a second warning list stored therein, and the message transmission and warning unit 303c has a third warning list stored therein.

Hereinbelow, operations of the vehicle collision avoidance apparatus of the present invention will be described with reference to different driving conditions. Firstly, a first detection result is generated by the distance detecting unit 302a of the second vehicle 302 when the distance detecting unit 302a detects that a distance d_{301,302} between the second vehicle 302 and the first vehicle 301 is smaller than a safe distance dₛ₍₃₀₂₎. Then, the message transmission and warning unit 302c transmits a first join-in message 302j to the first vehicle 301 in response to the first detection result. The message transmission and warning unit 301c adds the second vehicle 302 into the first warning list thereof in response to the first join-in message 302j, and transmits a reply message 301r to the message transmission and warning unit 302c. The response message 301r comprises a group identification (ID) G301 and a group serial number 1 of the first vehicle 301. The message transmission and warning unit 302c can learn from the group ID G301 in the reply message 301r that the second vehicle 302 belongs to the G301 group, and through calculation according to the group serial number 1 in the reply message 301r, learn that a self group serial number of the second vehicle 302 is 2, which represents that the second vehicle 302 is ranked the second in the G301 group.

In case the first vehicle 301 brakes, the message transmission and warning unit 301c transmits a first warning message 301w to vehicles in the first warning list according to the first warning list. In this example, it is the second vehicle 302 that is in the first warning list, so the message transmission and warning unit 301c transmits the first warning message 301w to the message transmission and warning unit 302c. The first warning message 301w further comprises a source ID G301, which represents that the first warning message 301w is transmitted by a vehicle belonging to the G301 group. Upon receiving the first warning message 301w, the message transmission and warning unit 302c firstly determines whether the source ID in the first warning message 301w is identical to the group ID of the second vehicle 302. If the answer is “yes”, then the message transmission and warning unit 302c sends out a warning notification in response to the first warning message 301w so that the driver of the second vehicle 302 can learn from the warning notification that his or her vehicle is not keeping a safe distance from the front vehicle and the front vehicle is braking. Thereby, the driver of the second vehicle 302 can decelerate or change to another lane instantaneously. Otherwise, if the answer is “no”, then the second vehicle 302 just ignores the first warning message 301w, and the message transmission and warning unit 302c abandons the first warning message 301w instead of sending out a warning notification.

On the other hand, the message transmission and warning unit 302c further determines that there is no vehicle in the second warning list of the second vehicle 302 (i.e., the second warning list is empty) after receiving the first warning message 301w. Then, the message transmission and warning unit 302c returns the first warning message 301w to the message transmission and warning unit 301c so that the message transmission and warning unit 301c can determine that the second vehicle has successfully received the first warning message 301w according to the first warning message 301w. Briefly speaking, by having the vehicle collision avoidance apparatus 1 return the warning message that is received, the sender of the warning message can confirm that the warning message has been successfully transmitted. This can avoid false determination of the vehicle collision avoidance apparatus 1 due to loss of the warning message in the transmission process or due to message transmission errors.

It shall be particularly noted that, in this embodiment, a warning notification is sent out by the message transmission and warning unit to warn the driver so that the driver can respond correspondingly; however in other embodiments, the message transmission and warning unit may also transmit the warning notification directly to an ECU or an electronic driving assistance system so that the ECU or the electronic driving assistance system can automatically decelerate the driving speed in response to the warning notification. Therefore, the way in which the vehicle responds after the message transmission and warning unit sends out the warning notification is not intended to limit the scope of the present invention.

Likewise, the message transmission and warning unit 303c of the third vehicle 303 transmits a second join-in message 303j to the second vehicle 302 when the distance detecting unit 303a detects that a distance d_{302,303} between the third vehicle 303 and the second vehicle 302 is smaller than a safe distance 4303) of the third vehicle 303. Then, the message transmission and warning unit 303c transmits a second join-in message 303j to the second vehicle 302. In response to the second join-in message 303j, the message transmission and warning unit 302c adds the third vehicle 303 into the second warning list so that the message transmission and warning unit 302c can transmit a second warning message to vehicles in the second warning list according to the second warning list when the second vehicle 302 brakes.

The message transmission and warning unit 302c transmits a reply message 302r to the message transmission and warning unit 303c in response to the second join-in message 303j. The reply message 302r comprises a group ID G301 and a group serial number 2 of the second vehicle 302. The message transmission and warning unit 303c can learn from the group ID G301 in the reply message 302r that the third vehicle 303 belongs to the G301 group, and through calculation according to the group serial number 2 in the reply message 302r, learn that the self group serial number of the third vehicle 303 is 3, which represents that the third vehicle 303 is ranked the third in the G301 group.

At this point, the first vehicle 301, the second vehicle 302 and the third vehicle 303 belong to the same group G301; i.e., the distance d_{301,302} is smaller than the safe distance dₛ₍₃₀₂₎ and the distance d_{302,303} is smaller than the safe distance dₛ₍₃₀₃₎. In this case, the first warning message 301w must be transmitted to, the second vehicle 302 and the third vehicle 303 when the first vehicle 301 brakes so that the second vehicle 302 and the third vehicle 303 can appropriately decelerate in response to the braking of the first vehicle 301. In practical applications, the message transmission and warning unit of the vehicle collision avoidance apparatus has a communication distance r, i.e., a maximum distance to which the message transmission and warning unit can transmit a signal. In this embodiment, assuming that the message transmission and warning unit has a communication distance r of 100 meters, then the first warning message 301w can only be transmitted to a range of 100 meters around the first vehicle 301 when the first vehicle 301 brakes.

On this condition, assuming that the distance d_{301,302} and the distance d_{302,303} are both 60 meters (i.e., the distance d_{301,303} is 120 meters) and the safe distance dₛ₍₃₀₂₎ is 80 meters, then the first warning message 301w can only be transmitted to the second vehicle 302 but cannot reach the third vehicle 303 because the third vehicle 303 is located beyond the communication distance r of the message transmission and warning unit 301c. To cope with this situation, the first warning message 301w further comprises a source serial number 1, which represents that the first warning message 301w is transmitted by a first vehicle in the G301 group; and the message transmission and warning unit 302c is further configured to: calculate a difference value between the self group serial number 2 and the source serial number 1 (i.e., x=2−1=1) after receiving the first warning message 301w, calculate a transfer distance t according to the communication distance r and the safe distance dₛ₍₃₀₂₎, determine that the difference value x is equal to the transfer distance t (i.e., x=t=1), and finally transmit the first warning message 301w to vehicles in the second warning list (i.e., to the third vehicle 303). Here, the transfer distance t is equal to an integer part of a value obtained by dividing the communication distance r by the safe distance dₛ₍₃₀₂₎ (i.e., t=[r/dₛ₍₃₀₂₎]=[100/80]=1).

Briefly speaking, the message transmission and warning unit of the present invention is further configured to determine whether it becomes a forwarding party by determining whether the difference value x is equal to the transfer distance t. If the answer is “no”, then it needs not to forward the warning message received; otherwise, if the answer is “yes”, then it forwards the warning message received. In this way, interruption of the warning message transmission caused when the distance between vehicles is greater than the communication distance of the message transmission and warning unit can be avoided.

Upon determining that it becomes a forwarding party, the message transmission and warning unit 302c transmits the first warning message 301w to the third vehicle 303. Because no vehicle is listed in a third warning list of the message transmission and warning unit 303c (i.e., the third warning list is empty), the message transmission and warning unit 303c can determine that the third vehicle 303 is the last vehicle in the group G301. In this case, the message transmission and warning unit 303c transmits the first warning message 301w to the second vehicle 302 so that the message transmission and warning unit 302c can know that the first warning message 301w has been successfully forwarded. On the other hand, after transmitting the first warning message 301w, the message transmission and warning unit 302c further determines whether the third vehicle 303 returns the first warning message 301w. If the answer is “yes”, it means that transmission of the warning message is successful and the message transmission and warning unit 302c can cease transmitting the first warning message 301w; otherwise, if the answer is “no”, it means that transmission of the warning message has failed and the message transmission and warning unit 302c must re-transmit the first warning message 301w until it receives the first warning message 301w returned by the third vehicle 303.

Next, driving conditions when the distance detecting unit 302a of the second vehicle 302 detects that the distance d_{301,302} between the second vehicle 302 and the first vehicle 301 is greater than the safe distance dₛ₍₃₀₂₎ will be described. In this case, a second detection result is generated by the distance detecting unit 302a. Then, the message transmission and warning unit 302c transmits a first leaving message 3021 to the first vehicle 301 in response to the second detection result, and the message transmission and warning unit 301c removes the second vehicle 302 from the first warning list thereof in response to the first leaving message 3021. Thus, the group G301 with the first vehicle 301 as a lead no longer comprises the second vehicle 302 and the third vehicle 303; i.e., the second vehicle 302 and the third vehicle 303 no longer belong to the group G301 in this case.

After the first leaving message 3021 is transmitted by the message transmission and warning unit 302c to the first vehicle 301, the group ID of the second vehicle 302 must be updated from G301 into G302 and the group serial number of the second vehicle 302 must be updated into 1, which represents that the second vehicle 302 has turned from the second vehicle of the group G301 into the first vehicle of the group G302. Because the second warning list of the second vehicle 302 still comprises the third vehicle 303, the message transmission and warning unit 302c is further configured to transmit a first update message 302u to the third vehicle 303 in the second warning list after updating of the group ID and the group serial number. The first update message 302u comprises the old group ID G301, the new group ID G302 and the new group serial number 1.

Upon receiving the first updating message 302u, the message transmission and warning unit 303c of the third vehicle 303 learns from the old group ID G301 that the group ID and the group serial number of the third vehicle 303 need to be updated. Then the message transmission and warning unit 303c updates the group ID of the third vehicle 303 into G302 according to the new group code G302, and updates the group serial number of the third vehicle 303 into 2 (which means that the third vehicle 303 now becomes the second vehicle in the group G302) according to the new group serial number 1.

In case the distance detecting unit 302a of the second vehicle 302 detects that the distance d_{301,302} between the second vehicle 302 and the first vehicle 301 is smaller than the safe distance dₛ₍₃₀₂₎ of the second vehicle 302 again, the message transmission and warning unit 301c adds the second vehicle 302 into the first warning list in response to this. Because the first warning list which originally comprises no vehicle has been updated to comprise the second vehicle 302, the message transmission and warning unit 301c transmits a second update message 301u to the second vehicle 302 comprised in the first warning list in response to join-in of the second vehicle 302. The second update message 301u comprises the old group ID G302, the new group ID G301 and the new group serial number 1. Likewise, the message transmission and warning unit 302c is further configured to receive the second update message 301u, update the group ID of the second vehicle 302 into G301 according to the second update message 301u and update the group serial number of the second vehicle 302 into 2, which means that the second vehicle 302 now becomes the second vehicle in the group G301.

Next, driving conditions when the distance detecting unit 303a of the third vehicle 303 detects that the distance d_{302,303} between the third vehicle 303 and the second vehicle 302 is greater than a safe distance dₛ₍₃₀₃₎ of the third vehicle 303 will be described. In this case, a third detection result is generated by the distance detecting unit 303a. The message transmission and warning unit 303c transmits a second leaving message 303l to the second vehicle 302 in response to the third detection result. Then, the message transmission and warning unit 302c removes the third vehicle 303 from the second warning list thereof in response to the second leaving message 303l so that the group G301 with the first vehicle 301 as a lead no longer comprises the third vehicle 303.

According to the above descriptions, the vehicles driving on the road are grouped in such a way that vehicles not keeping a safe distance are grouped into a same group, and when a front vehicle brakes, a back vehicle in the same group can receive a warning message transmitted by the front vehicle so as to decelerate correspondingly according to the warning message. This can effectively avoid vehicle collision events that tend to occur in dangerous driving conditions. Even further, by grouping the vehicles, the vehicle collision avoidance apparatus only needs to transmit a message to vehicles in the same group without having to transmit a lot of messages without limitation. This avoids waste of the wireless bandwidth resources on transmitting messages to vehicles that have already kept a safe distance or vehicles of a different group that are on different lanes. Thereby, wireless bandwidth resources consumed in communications between the vehicles can be effectively reduced and meanwhile, the probability of message packet collisions is lowered.

It shall be particularly noted that, the first vehicle 301, the second vehicle 302 and the third vehicle 303 are taken as an example in the first embodiment to describe the driving conditions and how the vehicle collision avoidance apparatus 1 groups the vehicles and provides the warning message according to the driving conditions. In other embodiments, more than three vehicles may be comprised in a same lane, and each of the vehicles may be equipped with a vehicle collision avoidance apparatus 1 to execute the operations and functions described in the first embodiment; how the other embodiments execute these operations and functions will be readily appreciated by those of ordinary skill in the art based on the explanation of the first embodiment, and thus will not be further described herein.

A second embodiment of the present invention is a vehicle collision avoidance method for the vehicle collision avoidance apparatus described in the first embodiment. The vehicle collision avoidance apparatus is configured to avoid collision with a first vehicle and is disposed on a second vehicle. The vehicle collision avoidance apparatus comprises a distance detecting unit and a message transmission and warning unit. The message transmission and warning unit is electrically connected to the distance detecting unit. The first vehicle has a first warning list, and the second vehicle is able to calculate a safe distance and is apart from the first vehicle by a distance.

The vehicle collision avoidance method described in the second embodiment may be implemented by a computer program product. When the computer program product is loaded into the vehicle collision avoidance apparatus and a plurality of codes comprised in the computer program product are executed, the vehicle collision avoidance method described in the second embodiment can be accomplished. The computer program product may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

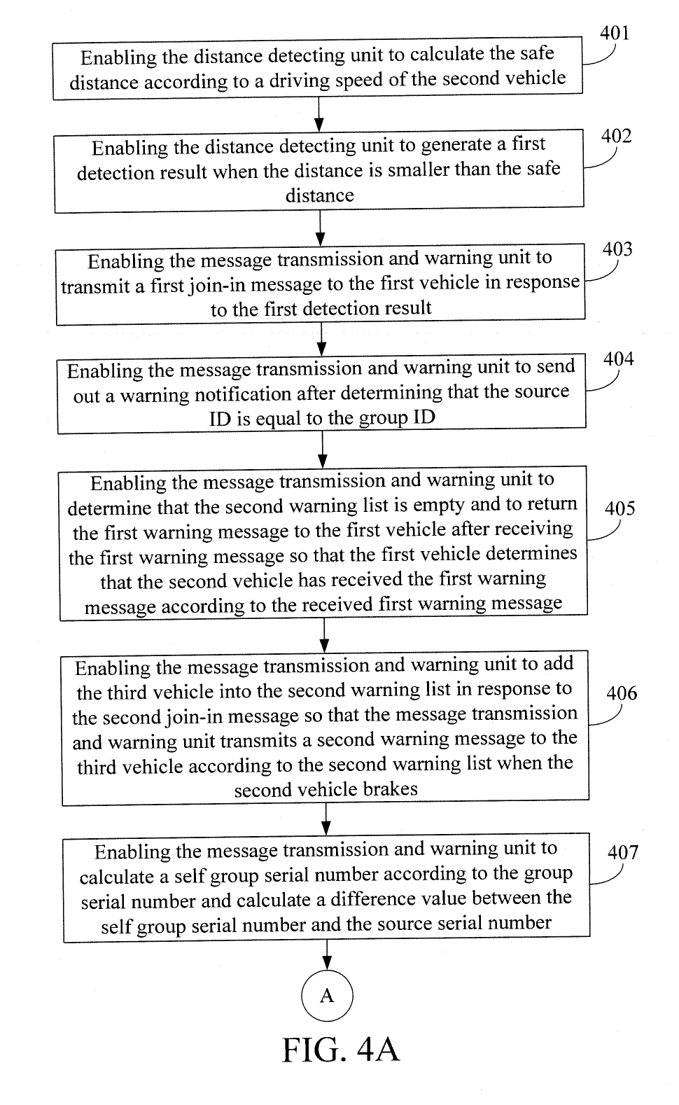

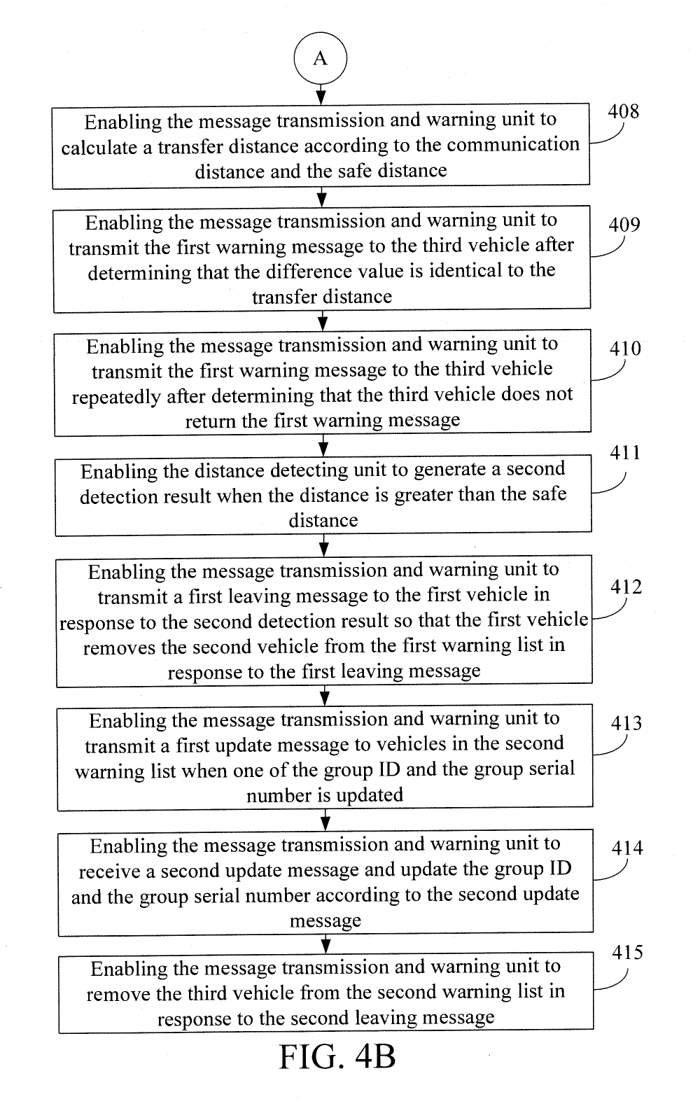

FIGS. 4A to 4B depict a flowchart of the vehicle collision avoidance method of the second embodiment. Firstly, step 401 is executed to enable the distance detecting unit to calculate the safe distance according to a driving speed of the second vehicle. Then, step 402 is executed to enable the distance detecting unit to generate a first detection result when the distance is smaller than the safe distance, and step 403 is executed to enable the message transmission and warning unit to transmit a first join-in message to the first vehicle in response to the first detection result. Further, step 404 is executed to enable the message transmission and warning unit to send out a warning notification. The first vehicle adds the second vehicle into the first warning list in response to the first join-in message so that the first vehicle transmits a first warning message to the message transmission and warning unit according to the first warning list when the first vehicle brakes, and the message transmission and warning unit is further configured to send out the warning notification in response to the first warning message.

Specifically, the first vehicle further transmits a group ID to the message transmission and warning unit in response to the first join-in message. The first warning message further comprises a source ID, and the step 404 is to enable the message transmission and warning unit to send out the warning notification after determining that the source ID is identical to the group ID.

Further, step 405 is executed to enable the message transmission and warning unit to determine that the second warning list is empty and to return the first warning message to the first vehicle after receiving the first warning message so that, according to the received first warning message, the first vehicle is assured that the second vehicle has received the first warning message.

The message transmission and warning unit further comprises a second warning list, there is further a third vehicle behind the second vehicle, and the third vehicle transmits a second join-in message to the message transmission and warning unit. Correspondingly, step 406 is further executed to enable the message transmission and warning unit to add the third vehicle into the second warning list in response to the second join-in message so that the message transmission and warning unit transmits a second warning message to the third vehicle according to the second warning list when the second vehicle brakes.

The first vehicle further transmits a group serial number to the message transmission and warning unit in response to the first join-in message, the first warning message further comprises a source serial number, and the message transmission and warning unit has a communication distance. Correspondingly, step 407 is further executed to enable the message transmission and warning unit to calculate a self group serial number according to the group serial number and calculate a difference value between the self group serial number and the source serial number. Next, step 408 is further executed to enable the message transmission and warning unit to calculate a transfer distance according to the communication distance and the safe distance, and step 409 is executed to enable the message transmission and warning unit to transmit the first warning message to the third vehicle after determining that the difference value is identical to the transfer distance. Here, the transfer distance is equal to an integer part of the communication distance divided by the safe distance. Then, step 410 is executed to enable the message transmission and warning unit to transmit the first warning message to the third vehicle repeatedly after determining that the third vehicle does not return the first warning message.

Additionally, step 411 is further executed to enable the distance detecting unit to generate a second detection result when the distance is greater than the safe distance. Then, step 412 is executed to enable the message transmission and warning unit to transmit a first leaving message to the first vehicle in response to the second detection result so that the first vehicle removes the second vehicle from the first warning list in response to the first leaving message.

Further, step 413 may be executed to enable the message transmission and warning unit to transmit a first update message to vehicles in the second warning list when one of the group ID and the group serial number is updated. Then, step 414 is executed to enable the message transmission and warning unit to receive a second update message and update the group ID and the group serial number according to the second update message.

When the third vehicle further transmits a second leaving message to the message transmission and warning unit, step 415 is further executed to enable the message transmission and warning unit to remove the third vehicle from the second warning list in response to the second leaving message.

In addition to the aforesaid steps, the second embodiment can also execute all the operations and functions set forth in the first embodiment. How the second embodiment executes these operations and functions will be readily appreciated by those of ordinary skill in the art based on the explanation of the first embodiment, and thus will not be further described herein.

According to the above descriptions, by disposing a vehicle collision avoidance apparatus on a vehicle, whether the vehicle keeps a safe distance from a front vehicle can be detected in real time by a distance detecting unit of the vehicle collision avoidance apparatus; and vehicles can be grouped by a message transmission and warning unit in the vehicle collision avoidance apparatus according to the detection result. Thus, when the vehicle brakes, the message transmission and warning unit can transmit a warning message to a back vehicle belonging to the same group as the vehicle so that the distance detecting unit of the back vehicle can send out a warning notification in response to the warning message and the back vehicle can respond appropriately in response to the warning notification. Thereby, the present invention can overcome the shortcomings of the conventional vehicle collision avoidance technologies that they must rely on the GPS, the periodical beacon advertisement and massive roadside infrastructure, and also has an advantage of saving the wireless bandwidth resources.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A vehicle collision avoidance apparatus for avoiding collision with a first vehicle, the first vehicle having a first warning list, the vehicle collision avoidance apparatus being disposed on a second vehicle, the second vehicle being able to calculate a safe distance and being apart from the first vehicle by a distance, the vehicle collision avoidance apparatus comprising:
an identification (ID) identifying unit, being configured to identify an ID of the first vehicle;
a distance detecting unit, being configured to generate a first detection result when the distance is less than the safe distance; and
a message transmission and warning unit, being electrically connected to the distance detecting unit, and being configured to transmit a first join-in message to the first vehicle, according to the ID of the first vehicle, in response to the first detection result;
wherein the first vehicle adds the second vehicle into the first warning list in response to the first join-in message so that the first vehicle transmits a first warning message to the message transmission and warning unit according to the first warning list when the first vehicle brakes, and the message transmission and warning unit is further configured to send out a warning notification in response to the first warning message.

2. The vehicle collision avoidance apparatus as claimed in claim 1, wherein the first vehicle further transmits a group identification (ID) to the message transmission and warning unit in response to the first join-in message, the first warning list further comprises a source ID, the message transmission and warning unit is further configured to send out the warning notification after determining that the source ID is identical to the group ID.

3. The vehicle collision avoidance apparatus as claimed in claim 1, wherein the message transmission and warning unit further comprises a second warning list and is further configured to determine that the second warning list is empty and return the first warning message to the first vehicle after receiving the first warning message so that the first vehicle determines that the second vehicle has received the first warning message according to the received first warning message.

4. The vehicle collision avoidance apparatus as claimed in claim 1, wherein the message transmission and warning unit further comprises a second warning list, there is further a third vehicle behind the second vehicle, the third vehicle transmits a second join-in message to the message transmission and warning unit, the message transmission and warning unit is further configured to add the third vehicle into the second warning list in response to the second join-in message so that the message transmission and warning unit transmits a second warning message to the third vehicle according to the second warning list when the second vehicle brakes.

5. The vehicle collision avoidance apparatus as claimed in claim 4, wherein the first vehicle further transmits a group serial number to the message transmission and warning unit in response to the first join-in message, the first warning message further comprises a source serial number, and the message transmission and warning unit has a communication distance and is further configured to:
calculate a self group serial number and calculate a difference value between the self group serial number and the source serial number;
calculate a transfer distance according to the communication distance and the safe distance;
transmit the first warning message to the third vehicle after determining that the difference value is identical to the transfer distance; and
transmit the first warning message to the third vehicle repeatedly after determining that the third vehicle does not return the first warning message;
wherein the transfer distance equals to an integer part of the communication distance divided by the safe distance.

6. The vehicle collision avoidance apparatus as claimed in claim 1, wherein the distance detecting unit is further configured to generate a second detection result when the distance is greater than the safe distance, the message transmission and warning unit is further configured to transmit a first leaving message to the first vehicle in response to the second detection result so that the first vehicle removes the second vehicle from the first warning list in response to the first leaving message.

7. The vehicle collision avoidance apparatus as claimed in claim 5, wherein the message transmission and warning unit is further configured to transmit a first update message to vehicles in the second warning list when one of the group ID and the group serial number is updated, receive a second update message and update the group ID and the group serial number according to the second update message.

8. The vehicle collision avoidance apparatus as claimed in claim 4, wherein the third vehicle further transmits a second leaving message to the message transmission and warning unit, and the message transmission and warning unit further removes the third vehicle from the second warning list in response to the second leaving message.

9. A vehicle collision avoidance method for a vehicle collision avoidance apparatus, the vehicle collision avoidance apparatus being configured to avoid collision with a first vehicle and being disposed on a second vehicle, and comprising an identification (ID) identifying unit, a distance detecting unit and a message transmission and warning unit, the ID identifying unit being configured to identify an ID of the first vehicle so that the message transmission and warning unit can transmit a message according to the ID of the first vehicle, the message transmission and warning unit being electrically connected to the distance detecting unit, the first vehicle having a first warning list, the second vehicle being able to calculate a safe distance and being apart from the first vehicle by a distance, the vehicle collision avoidance method comprising the following steps of:
(a) enabling the distance detecting unit to generate a first detection result when the distance is less than the safe distance;
(b) enabling the message transmission and warning unit to transmit a first join-in message to the first vehicle in response to the first detection result; and
(c) enabling the message transmission and warning unit to send out a warning notification;
wherein the first vehicle adds the second vehicle into the first warning list in response to the first join-in message so that the first vehicle transmits a first warning message to the message transmission and warning unit according to the first warning list when the first vehicle brakes, and the message transmission and warning unit is further configured to send out the warning notification in response to the first warning message.

10. The vehicle collision avoidance method as claimed in claim 9, wherein the first vehicle further transmits a group ID to the message transmission and warning unit in response to the first join-in message, the first warning message further comprises a source ID, and the step (c) is a step of enabling the message transmission and warning unit to send out the warning notification after determining that the source ID is identical to the group ID.

11. The vehicle collision avoidance method as claimed in claim 9, wherein the message transmission and warning unit further comprises a second warning list, the vehicle collision avoidance method further comprises the following steps of:
(d) enabling the message transmission and warning unit to determine that the second warning list is empty and return the first warning message to the first vehicle after receiving the first warning message so that the first vehicle determines that the second vehicle has received the first warning message according to the received first warning message.

12. The vehicle collision avoidance method as claimed in claim 9, wherein the message transmission and warning unit further comprises a second warning list, there is further a third vehicle behind the second vehicle, the third vehicle transmits a second join-in message to the message transmission and warning unit, the vehicle collision avoidance method further comprises the following steps of:
(e) enabling the message transmission and warning unit to add the third vehicle into the second warning list in response to the second join-in message so that the message transmission and warning unit transmits a second warning message to the third vehicle according to the second warning list when the second vehicle brakes.

13. The vehicle collision avoidance method as claimed in claim 12, wherein the first vehicle further transmits a group serial number to the message transmission and warning unit in response to the first join-in message, the first warning message further comprises a source serial number, the message transmission and warning unit has a communication distance, the vehicle collision avoidance method further comprises the following steps of:
(f) enabling the message transmission and warning unit to calculate a self group serial number and calculate a difference value between the self group serial number and the source serial number;
(g) enabling the message transmission and warning unit to calculate a transfer distance according to the communication distance and the safe distance;
(h) enabling the message transmission and warning unit to transmit the first warning message to the third vehicle after determining that the difference value is identical to the transfer distance;
(i) enabling the message transmission and warning unit to transmit the first warning message to the third vehicle repeatedly after determining that the third vehicle does not return the first warning message;
(j) enabling the message transmission and warning unit to transmit a first update message to vehicles in the second warning list when one of the group ID and the group serial number is updated; and
(k) enabling the message transmission and warning unit to receive a second update message and update the group ID and the group serial number according to the second update message;
wherein the transfer distance equals to integer part of the communication distance divided by the safe distance.

14. The vehicle collision avoidance method as claimed in claim 9, further comprising the following steps of:
(l) enabling the distance detecting unit to generate a second detection result when the distance is greater than the safe distance; and
(m) enabling the message transmission and warning unit to transmit a first leaving message to the first vehicle in response to the second detection result so that the first vehicle removes the second vehicle from the first warning list in response to the first leaving message.

15. The vehicle collision avoidance method as claimed in claim 12, wherein the third vehicle further transmits a second leaving message to the message transmission and warning unit, the vehicle collision avoidance method further comprises the following steps of:
(n) enabling the message transmission and warning unit to remove the third vehicle from the second warning list in response to the second leaving message.

16. A computer program product, storing a program of a vehicle collision avoidance method for a vehicle collision avoidance apparatus, the vehicle collision avoidance apparatus being configured to avoid collision with a first vehicle, being disposed on a second vehicle, and comprising an identification (ID) identifying unit, a distance detecting unit and a message transmission and warning unit, the ID identifying unit being configured to identify an ID of the first vehicle so that the message transmission and warning unit can transmit a message according to the ID of the first vehicle, the message transmission and warning unit being electrically connected to the distance detecting unit, the first vehicle having a first warning list, the second vehicle being able to calculate a safe distance and being apart from the first vehicle by a distance, the program comprising:
a code A for enabling the distance detecting unit to generate a first detection result when the distance is less than the safe distance;
a code B for enabling the message transmission and warning unit to transmit a first join-in message to the first vehicle in response to the first detection result; and
a code C for enabling the message transmission and warning unit to send out a warning notification;
wherein the first vehicle adds the second vehicle into the first warning list in response to the first join-in message so that the first vehicle transmits a first warning message to the message transmission and warning unit according to the first warning list when the first vehicle brakes, the message transmission and warning unit is further configured to send out the warning notification.

17. The computer program product as claimed in claim 16, wherein the first vehicle further transmits a group ID to the message transmission and warning unit in response to the first join-in message, the first warning message further comprises a source ID, the code C is a code for enabling the message transmission and warning unit to send out the warning notification after determining that the source ID is identical to the group ID.

18. The computer program product as claimed in claim 16, wherein the message transmission and warning unit further comprises a second warning list, the program further comprises:
a code D for enabling the message transmission and warning unit to determine that the second warning list is empty and return the first warning message to the first vehicle after receiving the first warning message so that the first vehicle determines that the second vehicle has received the first warning message according to the received first warning message.

19. The computer program product as claimed in claim 16, wherein the message transmission and warning unit further comprises a second warning list, there is further a third vehicle behind the second vehicle, the third vehicle transmits a second join-in message to the message transmission and warning unit, the program further comprises:
a code E for enabling the message transmission and warning unit to add the third vehicle into the second warning list in response to the second join-in message so that the message transmission and warning unit transmits a second warning message to the third vehicle according to the second warning list when the second vehicle brakes.

20. The computer program product as claimed in claim 19, wherein the first vehicle further transmits a group serial number to the message transmission and warning unit in response to the first join-in message, the first warning message further comprises a source serial number, the message transmission and warning unit has a communication distance, the program further comprises:
a code F for enabling the message transmission and warning unit to calculate a self group serial number and calculate a difference value between the self group serial number and the source serial number;
a code G for enabling the message transmission and warning unit to calculate a transfer distance according to the communication distance and the safe distance;
a code H for enabling the message transmission and warning unit to transmit the first warning message to the third vehicle after determining that the difference value is identical to the transfer distance;
a code I for enabling the message transmission and warning unit to transmit the first warning message to the third vehicle repeatedly after determining that the third vehicle does not return the first warning message;
a code J for enabling the message transmission and warning unit to transmit a first update message to vehicles in the second warning list when one of the group ID and the group serial number is updated; and
a code K for enabling the message transmission and warning unit to receive a second update message and update the group ID and the group serial number according to the second update message;
wherein the transfer distance equals to integer part of the communication distance divided by the safe distance.

21. The computer program product as claimed in claim 16, wherein the program further comprises:
a code L for enabling the distance detecting unit to generate a second detection result when the distance is greater than the safe distance; and
a code M for enabling the message transmission and warning unit to transmit a first leaving message to the first vehicle in response to the second detection result so that the first vehicle removes the second vehicle from the first warning list in response to the first leaving message.

22. The computer program product as claimed in claim 19, wherein the third vehicle further transmits a second leaving message to the message transmission and warning unit, the program further comprises:
a code N for enabling the message transmission and warning unit to remove the third vehicle from the second warning list in response to the second leaving message.
